(19) United States
(12) Patent Application Publication
(10) Pub. No.: US 2010/0085156 A1
(43) Pub. Date: Apr. 8, 2010

(54) APPARATUS, SYSTEMS AND METHODS FOR IDENTIFYING PATCH CORDS IN HIGH DENSITY CONNECTOR PORT CONFIGURATIONS

(75) Inventor: Peter T. Tucker, Dallas, TX (US)

Correspondence Address: MYERS BIGEL SIBLEY & SAJOVEC, P.O. BOX 37428, RALEIGH, NC, 27612, US

(73) Assignee: CommScope, Inc.

(21) Appl. No.: 12/246,695

(22) Filed: Oct. 7, 2008

(51) Int. Cl. H04Q 5/22; H01R 29/00

(52) U.S. Cl. 340/10.1; 439/49

(57) ABSTRACT

An RFID tag includes an accelerometer that is configured to determine an orientation of the RFID tag and to generate an orientation signal associated with the RFID tag orientation when the RFID tag is energized. The accelerometer may be a single axis accelerometer that is configured to determine the orientation of the RFID tag relative to earth. A patch cord for a communications patching system includes a cable and a connector secured to an end of the cable. An RFID tag is secured to the connector and includes an identifier stored therewithin. The RFID tag emits the identifier when energized by via an RFID transceiver. In addition, the REID tag includes an accelerometer that is configured to determine an orientation of the RFID tag and to generate an orientation signal associated with the RFID tag orientation when the RFID tag is energized.

### FIELD OF THE INVENTION

The present invention relates generally to communications systems and, more particularly, to communications patching systems.

### BACKGROUND

Many businesses have dedicated communications systems that enable computers, servers, printers, facsimile machines and the like to communicate with each other, through a private network, and with remote locations via a telecommunications service provider. In, for example, commercial office buildings, the dedicated communications system may be hard wired using communications cables that contain conductive wire. In such hard wired systems, individual connector ports such as modular wall jacks are mounted in offices throughout the building. Communications cables are run through, for example, the walls and/or ceiling of the building to electrically connect each connector port to network equipment (e.g., network servers) that are located in, for example, a telecommunications closet or computer room. Communications cables from external telecommunication service providers may also terminate within the computer room or telecommunications closet.

Communications patching systems are often used to interconnect the various communication cables within a computer room or telecommunications closet. These communications patching systems may facilitate terminating the cables in an organized fashion, and may also simplify the process for later making changes to the connections between communications cables. Typically, a communications patching system includes one or more mounting frames, usually in the form of equipment racks. Network equipment such as, for example, network servers and switches may be mounted on these mounting frames, as may one or more “patch panels.” As is known to those of skill in the art, a “patch panel” refers to an interconnect device that includes a plurality of connector ports such as, for example, communications jacks or fiber optic couplers on at least one side thereof. Each connector port (e.g., a jack) is configured to receive a communications cable that is terminated with a mating connector (e.g., a plug). One or more communications cables may also be terminated into a reverse side of the patch panel (the communications wires of each cable can be terminated into individual contacts or couplers such as, for example, insulation displacement contacts that are often used to terminate the conductors of a twisted pair cable, or may be terminated using a connector port such as would be the case with an RJ-45-to-RJ-45 patch panel). Each connector port on the patch panel may provide communications paths between a communications cable that is plugged into the connector port and a respective one of the communications cables that is terminated into the reverse side of the patch panel. Communications patching systems are typically used to connect individual connector ports in offices throughout the building to, for example, network equipment in the computer room of the building.

FIG. 1 is a simplified example of one way in which a computer 26 in an office or other room 4 of a building may be connected to network equipment 52, 54 located in, for example, a computer room 2 of the building. As shown in FIG. 1, the computer 26 is connected by a patch cord 28 to a modular wall jack 22 that is mounted in a wall plate 24 in office 4. A communications cable 20 is routed from the back end of the modular wall jack 22 through, for example, the walls and/or ceiling of the building, to the computer room 2. As there will often be hundreds or thousands of wall jacks 22 within an office building, a large number of cables 20 are routed into the computer room 2.

A first equipment rack 10 is provided within the computer room 2. A plurality of patch panels 12 are mounted on the first equipment rack 10. Each patch panel 12 includes a plurality of connector ports 16. In FIG. 1, each connector port 16 comprises a modular RJ-45 jack that is configured to receive a modular RJ-45 plug connector. However, it will be appreciated that other types of patch panels may be used such as, for example, patch panels with optical fiber connector ports 16 (e.g., SC, ST, and LC ports) or patch panels with other types of twisted copper wire pair connector ports 16 (e.g., RJ-11 ports).

As shown in FIG. 1, each communications cable 20 that provides connectivity between the computer room 2 and the various offices 4 in the building is terminated onto the back end of one of the connector ports 16 of one of the patch panels 12 on equipment rack 10. A second equipment rack 30 is also provided in the computer room 2. A plurality of patch panels 12′ that include connector ports 16′ are mounted on the second equipment rack 30. A first set of patch cords 40 (only two exemplary patch cords 40 are illustrated in FIG. 1) are used to interconnect connector ports 16 on the patch panels 12 to respective ones of the connector ports 16′ on the patch panels 12′. The first and second equipment racks 10, 30 may be located in close proximity to each other (e.g., side-by-side) to simplify the routing of the patch cords 40.

As is further shown in FIG. 1, network equipment such as, for example, one or more switches 52 and network routers and/or servers 54 (“network devices”) are mounted on a third equipment rack 50. Each of the switches 52 may include a plurality of connector ports 53. A second set of patch cords 60 connect the connector ports 53 on the switches 52 to the back end of respective ones of the connector ports 16′ on the patch panels 12′. As is also shown in FIG. 1, a third set of patch cords 64 may be used to interconnect other of the connector ports 53 on the switches 52 with connector ports 55 provided on the network devices 54. In order to simplify FIG. 1, only a single patch cord 60 and a single patch cord 64 are shown. Finally, one or more external communications lines 66 are connected to, for example, one or more of the network devices 54. In many instances, the communication lines 66 would terminate onto a patch panel and be connected to the network device 54 via a patch cord. For simplicity, the external communication line 66 is pictured as a cable/cord 66 in FIG. 1, which may be the actual external communication line or, alternatively, may be a patch cord that is connected to a patch panel connector port which the actual external communication line is terminated into.

The communications patching system of FIG. 1 may be used to connect each computer, printer, facsimile machine and the like 26 located throughout the building to local area network (“LAN”) switches 52, the LAN switches 52 to network routers 54, and the network routers 54 to external communications lines 66, thereby establishing the physical connectivity required to give devices 26 access to both local and wide area networks. In the patching system of FIG. 1, connectivity changes are typically made by rearranging the patch cords 40 that interconnect the connector ports 16 on the patch panels 12 with respective connector ports 16′ on the patch panels 12′.

The equipment configuration shown in FIG. 1, in which each wall jack 22 is connected to the network equipment 52, 54 through at least two patch panels 12, 12′, is referred to as a “cross-connect” patching system. In another commonly used equipment configuration, which is typically referred to as “inter-connect” patching system, the communications path from each modular wall jack 22 to the network devices 54 typically passes through a single patch panel 12.

FIG. 2 depicts a simplified version of an inter-connect patching system that is used to connect a plurality of computers 126 (and other networked equipment) located in the rooms 104 throughout an office building to a plurality of network devices 154 that are located in a computer room 102 of the building. As shown in FIG. 2, a plurality of patch panels 112 are mounted on a first equipment rack 110. Each patch panel 112 includes a plurality of connector ports 116. A plurality of communications cables 120 are routed from wall jacks 122 in offices 104 into the computer room 102 and connected to the reverse side of the patch panels 112. The computers 126 are connected to respective modular wall jacks 122 by patch cords 128.

As is further shown in FIG. 2, network equipment such as, for example, one or more network devices 154, are mounted on a second equipment rack 150. One or more external communications lines 166 are connected (typically through one or more patch panels and patch cords) to one or more of the network devices 154. A plurality of switches 152 that include a plurality of connector ports 153 are also provided. The switches 152 may be connected to the network devices 154 using a first set of patch cords 164 (only one patch cord 164 is shown in FIG. 2). A second set of patch cords 160 (only one patch cord 160 is shown in FIG. 2) are used to interconnect the connector ports 116 on the patch panels 112 with respective of the connector ports 153 on the switches 152. In the patching system of FIG. 2, connectivity changes are typically made by rearranging the patch cords 160 that interconnect the connector ports 116 on the patch panels 112 with respective connector ports 153 on the switches 152.

The patch cords in a telecommunications closet may be rearranged quite often. The interconnections of the various patch cords in a telecommunications closet are typically logged in either a paper or computer-based log. However, technicians may neglect to update the log each and every time a change is made, and/or may make errors in logging changes. As such, paper- or computer-based logs may not be 100 percent accurate so that a technician cannot have full confidence from reading the log where each of the patch cords begins and ends. Accordingly, each time a technician needs to change a patch cord, the technician often manually traces that patch cord between two connector ports. To perform a manual trace, the technician locates one end of a patch cord and then manually follows the patch cord until he/she finds the opposite end of that patch cord.

Due to the large number of patch cords that are typically used at any one time and/or the cable routing mechanisms that are often used to keep the cable of each patch cord neatly routed, it may take a significant amount of time for a technician to manually trace a particular patch cord. Furthermore, manual tracing may not be completely accurate as technicians may accidentally switch from one patch cord to another during a manual trace. Such errors may result in misconnected communication cables which must be later identified and corrected. Thus, ensuring that the proper connections are made can be time-consuming, and the process is prone to errors in both the making of connections and in keeping records of the connections.

### SUMMARY

In view of the above discussion, apparatus, systems and methods of identifying patch cords in high density connector port configurations are provided. According to some embodiments of the present invention, a radio frequency identification (RFID) tag includes an accelerometer that is configured to determine an orientation of the RFID tag and to generate an orientation signal associated with the RFID tag orientation when the RFID tag is energized. The accelerometer may be a single axis accelerometer that is configured to determine the orientation of the RFID tag relative to the gravitational field of the earth.

According to some embodiments of the present invention, a patch cord for a communications patching system includes a cable and a connector (e.g., optical connector, electrical connector, etc.) secured to (i.e., at or near) an end of the cable. An RFID tag is secured to the connector and includes an identifier stored therewithin. The RFID tag emits the identifier when energized via an RFID transceiver. In addition, the RFID tag includes an accelerometer that is configured to determine an orientation of the RFID tag and to generate an orientation signal associated with the RFID tag orientation when the RFID tag is energized. In some embodiments, a patch cord includes connectors at each end thereof with respective RFID tags secured to each connector. The RFID tags may have the same unique identifier stored therewithin.

According to some embodiments of the present invention, a communications patching system includes a communications device comprising one or more connector ports, an RFID transceiver, and at least one patch cord having a connector secured to an end thereof. The patch cord connector is configured to be removably secured within a connector port. The patch cord connector has an RFID tag secured thereto, and the RFID tag includes an accelerometer that is configured to determine an orientation of the RFID tag and to generate an orientation signal associated with the RFID tag orientation when the RFID tag is energized by the RFID transceiver. The RFID tag has an identifier stored therewithin, and the RFID tag is configured to transmit the identifier when the RFID tag is energized via the RFID transceiver.

According to some embodiments of the present invention, methods of determining patch cord connectivity information in a patching system are provided. For example, a patching system includes a pair of connector ports, an RFID antenna adjacent the pair of connector ports, and a respective pair of patch cords inserted within the connector ports. Each patch cord includes an RFID tag having an accelerometer that is configured to determine an orientation of the RFID tag and to generate an orientation signal associated with the RFID tag orientation when the RFID tag is energized. A method includes energizing the patch cord RFID tags to cause each accelerometer to determine an orientation of its RFID tag and to emit an orientation signal, receiving the orientation signal of each RFID tag, and identifying which patch cord is inserted within which connector port using the received orientation signals. In some embodiments of the present invention, the orientation signal of each RFID tag may be received by an RFID transceiver according to an arbitration protocol.

### BRIEF DESCRIPTION OF THE DRAWINGS

FIG. 1 is a schematic view of a simplified prior art cross-connect communications patching system.

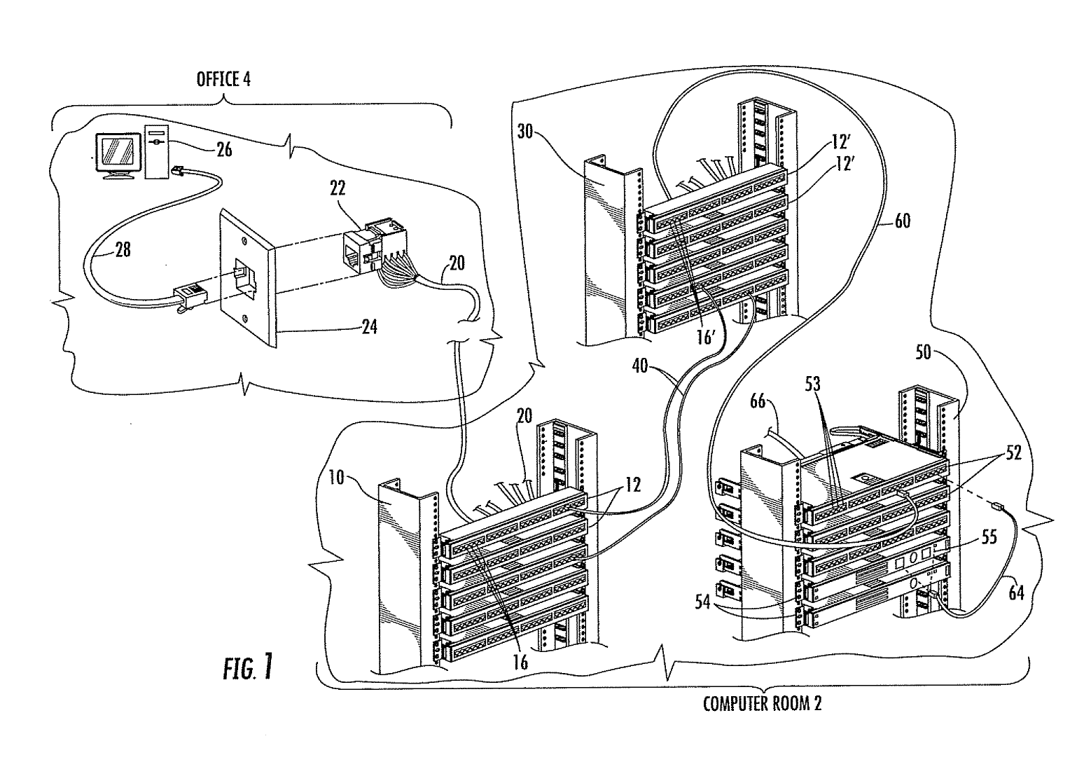

FIG. 2 is a schematic view of a simplified prior art inter-connect communications patching system.

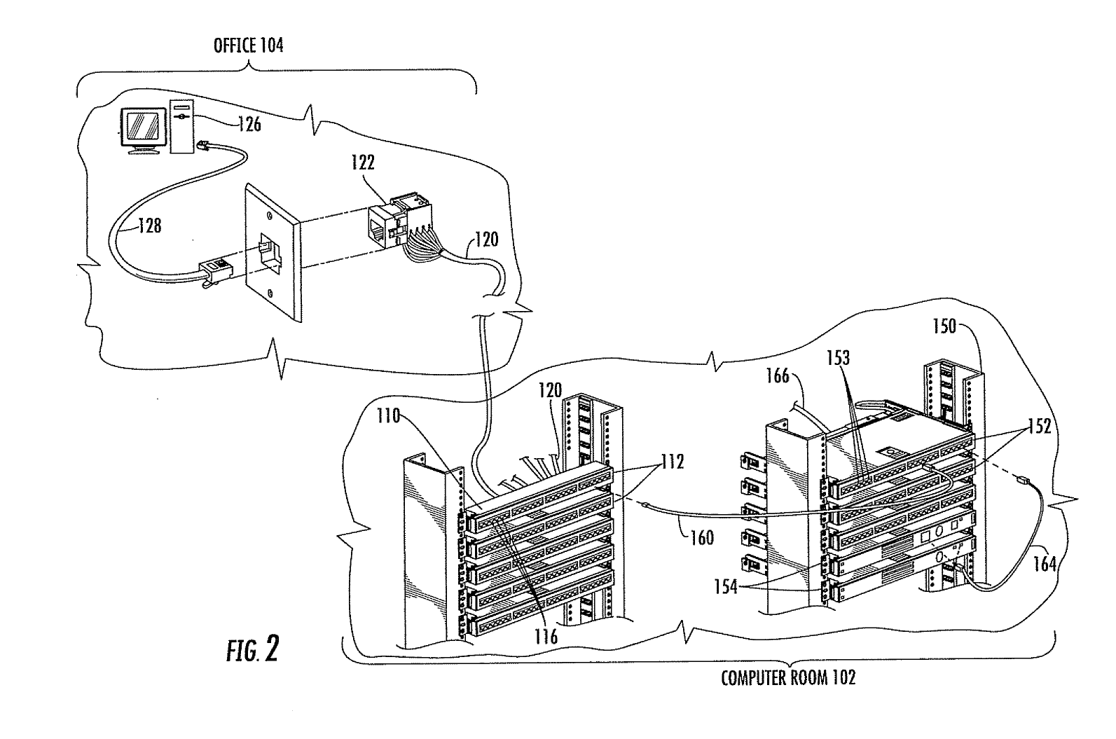

FIG. 3 is a schematic diagram illustrating operation of a radio frequency identification system.

FIG. 4 is a perspective view of an intelligent patch panel that may be used in communications patching system according to embodiments of the present invention.

FIG. 5 is a front view of a communications device, such as a LAN switch, having two rows of connector ports arranged in a high density configuration.

FIG. 6 is a schematic diagram illustrating an RFID tag according to some embodiments of the present invention.

### DETAILED DESCRIPTION

The present invention now is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

It will be understood that, although the terms “first”, “second”, etc. may be used herein to describe various elements, components, patch panels, etc., these elements, components, patch panels etc. should not be limited by these terms. These terms are only used to distinguish one element, component, patch panel, etc. from another element, component, patch panel. Thus, a “first” element, component, or patch panel discussed below could also be termed a “second” element, component, or patch panel without departing from the teachings of the present invention. In addition, the sequence of operations (or steps) is not limited to the order presented in the claims or figures unless specifically indicated otherwise.

Communications patching systems are known in the art that automate the process of detecting and identifying the ends of patch cords used therein. For example, U.S. Pat. No. 6,222,908 describes a communications patching system in which each patch cord connector (e.g., plug) includes a unique identifier, and each connector port on the patch panels includes a sensor that reads the unique identifier on any patch cord connector inserted therein. Similarly, U.S. Pat. No. 6,784,802 describes a communications patching system for monitoring connectivity in a communications patching system that includes radio frequency identification (“RFID”) transponders or “tags” on the ends of each patch cord and RFID sensors adjacent each connector port of the patch panels. In this system, the RFID tags on each patch cord have a unique identifier that differs from the RFID tags on all other patch cords, and this unique identifier is transmitted by the RFID tag. Each RFID sensor is capable of receiving the unique identifier transmitted by the RFID tag on a patch cord that is inserted into the connector port associated with the RFID sensor. If all of the connector ports in the system include RFID sensors, then the systems described in U.S. Pat. No. 6,784,802 may be used to automatically determine the connector ports on the patch panels that each patch cord is plugged into.

One limitation, however, of such existing systems for automatically tracking connectivity information in a communications patching system is that these systems generally require that both ends of the patch cords be plugged into the connector ports of “intelligent” patch panels (i.e., patch panels that have the capability to automatically identify the patch cords that are plugged into the connector ports on the patch panel). As such, the automated tracking capabilities of existing intelligent patch panels typically cannot be utilized in inter-connect communications patching systems, as in inter-connect systems, the patch cords connect a patch panel to a network switch or other piece of network equipment. While intelligent patch panels are commercially available, “intelligent” switches that include the capability to automatically determine the patch cords that are plugged into the connector ports thereof are generally not available. As a result, even if intelligent patch panels are used in an inter-connect system, the patching system may be unable to automatically track full patch cord connectivity information, as connectivity information may not be automatically gathered for the end of the patch cord that is inserted directly into the non-intelligent network equipment. This same problem may also arise in cross-connect systems which include, for example, some RFID-enabled patch panels and some non-RFID-enabled patch panels.

Pursuant to embodiments of the present invention, apparatus, systems and methods are provided that facilitate determining patch cord connectivity information in inter-connect and cross-connect communications patching systems, and particularly in systems having a high density connector port configuration. The apparatus, systems and methods according to embodiments of the present invention may be used on, for example, conventional patch panels, switches, or other network equipment that do not include automated connectivity tracking capabilities (i.e., on “non-intelligent” devices). Accordingly, the apparatus, systems and methods of the present invention may facilitate automatically tracking connectivity information in inter-connect communication patching systems which include non-intelligent switches. The disclosed apparatus, systems and methods may also allow customers to automatically track connectivity information without replacing existing non-intelligent patch panels, and may allow such automatic tracking in communications patching systems that include equipment (e.g., non-intelligent patch panels) provided by multiple different vendors.

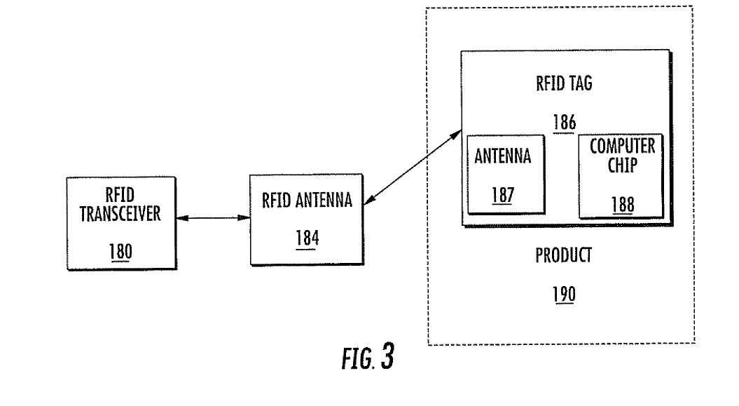

In specific embodiments of the present invention, RFID technology is used to implement the intelligent patching aspects of the present invention. As is known to those of skill in the art, RFID refers to a class of applications in which items that are to be tracked are “tagged” with an RFID tag. An RFID tag is a specially designed electronic tag, which is typically implemented as the combination of a computer chip and an antenna, that is placed on, or embedded in, an object. These RFID tags work in conjunction with an RFID transceiver and an RFID antenna. An “RFID transceiver” refers to a class of circuit(s), chip(s) or device(s) that transmit a signal that may be used to (a) energize or “excite” an RFID tag and (b) receive and demodulate and/or decode information that is transmitted by the energized RFID tag. The RFID transceiver may comprise a single circuit, chip or device, or may comprise multiple circuits, chips and/or devices. A variety of RFID transceivers are commercially available such as, for example, the Philips HTRC110 IC RFID transceiver. RFID antennas refer to a type of antenna that emits a field in response to receiving a signal from, for example, an RFID transceiver. The RFID antenna may also receive and pass to the RFID transceiver a signal that is transmitted from an excited RFID tag. Operation of the principles of radio frequency identification will now be described with reference to FIG. 3.

As shown in FIG. 3, an RFID transceiver 180 sends a signal to an RFID antenna 184. The RFID antenna 184 broadcasts the signal as a radio frequency (“RF”) broadcast signal. This RF broadcast signal may comprise, for example, an alternating current signal of fixed amplitude and frequency, with the frequency matching the resonance frequency of the RFID tags that are to be read. As is also shown in FIG. 3, an RFID tag 186 is mounted or embedded in a product 190, such as a patch cord connector, etc. The RFID tag 186 includes an antenna 187 and a computer chip 188 in which a unique identifier is stored. The antenna 187 receives the RF broadcast signal. This received RF broadcast signal energizes the RFID tag 186, causing the RFID tag 186 to transmit information back to the RFID transceiver 180 by altering the load placed by the RFID tag 186 on the RF broadcast signal that is transmitted by the RFID antenna 184. This variation in load causes the amplitude of the RF broadcast signal to vary over time. The information transmitted by the RFID tag 186 to the RFID transceiver 180 includes the unique identifier that is stored in the memory of the RFID tag 186 (and perhaps other information as well). The RFID transceiver 180 detects these variations in the amplitude of the RE broadcast signal, demodulates them, and converts them from an analog signal to a digital signal. A microcontroller (which may, for example, be embedded within the RFID transceiver 180 or which may be a separate controller) may then determine the unique identifier associated with the RFID tag 186 from this digital signal. In this manner, the RFID system can identify and track each RFID tagged product 190 that comes within a specified range of the RFID antenna 184.

RFID techniques may also be used to identify which specific patch cords are plugged into the connector ports of patch panels or other equipment such as, for example, switches that are part of a communications patching system. In order to accomplish this, an array of RFID antennas may be provided such that, for example, each connector port may have its own associated RFID antenna. Each RFID antenna may be intentionally designed to be a low efficiency antenna that emits a field that covers only a very small area so that the RFID antenna associated with a first connector port will not energize RFID tags on patch cords inserted into other connector ports. One or more RFID transceivers are also provided.

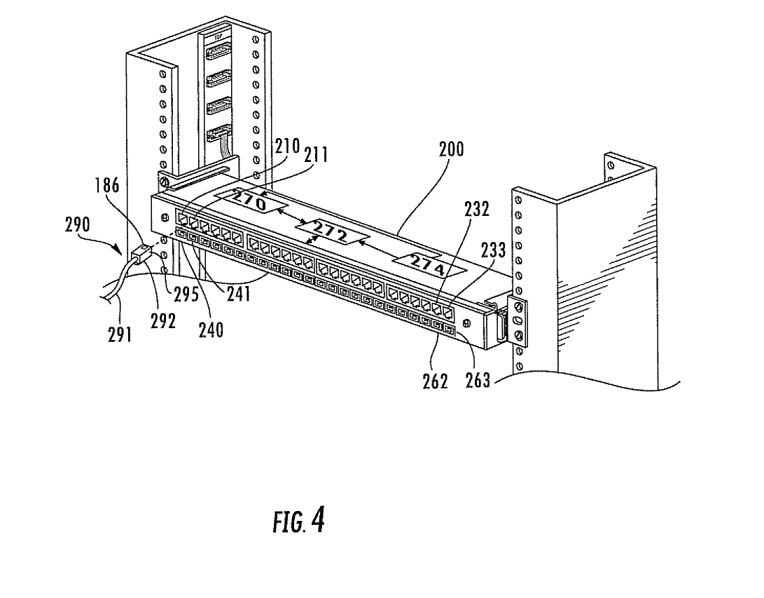

FIG. 4 is a perspective view of an intelligent patch panel 200 and an intelligent patch cord 290. As shown in FIG. 4, the intelligent patch cord includes a cable 291. A connector 292 is terminated on each end of the cable 291 (only one end of patch cord 290 is shown in FIG. 4). In the depicted embodiment, the cable 291 contains four twisted wire pairs, and the connectors 292 comprise RJ-45 plug connectors. However, it will be appreciated that other types of cables and connectors including, without limitation, fiber optic cables and connectors and other types of copper twisted pair cables and connectors (e.g., RJ-11 style, 25-pair, shielded cables and connectors, etc.) may be used in an intelligent patching system. An RFID tag 186 is embedded in each of the connectors 292. As discussed above with respect to FIG. 3, each RFID tag 186 may include an antenna and a computer chip. The computer chip may include a memory that stores at least one identifier 295. Typically, the identifiers 295 stored in the memories of the RFID tags 186 included on the two connectors of a particular patch cord will be identical, but this identifier 295 will be different than the identifiers 295 stored in the memories of the RFID tags 186 included on all of the other patch cords 290 that may be used in the communications patching system.

As is also shown in FIG. 4, the intelligent patch panel 200 includes a plurality of connector ports 210-233, a plurality of RFID antennas 240-263, an RFID transceiver 270, a switching circuit 272 and a controller 274. In order to simplify FIG. 4, the RFID transceiver 270, the switching circuit 272 and the a controller 274 are illustrated schematically as functional blocks. These components may be implemented in a variety of ways such as, for example, in the manner described in co-pending U.S. patent application Ser. No. 11/871,448, filed Oct. 12, 2007, the entire contents of which are incorporated by reference herein. Each of the RFID antennas 240-263 are located at or adjacent to a respective one of the connector ports 210-233. While in the depicted embodiment each RFID antenna 240-263 is located directly below its corresponding connector port 210-233, it will be appreciated that, in other embodiments, the RFID antennas 240-263 may be located, for example, above, to one side oft behind or below the aperture of their corresponding connector ports 210-233.

The RFID transceiver 270 may be used to sequentially activate each RFID antenna 240-263. Each of the RFID antennas 240-263 may be designed to have a very small emission field such that the signal it transmits will only be received by the RFID tags 186 on intelligent patch cords 290 that are inserted into the connector port that is located directly above the RFID antenna, and will not be received by the RFID tags 186 on intelligent patch cords 290 that are inserted into any of the other connector ports on the patch panel 200. As such, when a particular RFID antenna (e.g., RFID antenna 240) is activated, the RFID transceiver 270 can, based on the signal (if any) received by RFID antenna 240, determine the unique identifier 295 that is stored in the memory of any RFID tag 186 that is mounted on an intelligent patch cord 290 that is plugged into the respective one of the connector ports (connector port 210) that is associated with RFID antenna 240.

The controller 274 may be implemented, for example, using a printed circuit board mountable microcontroller. The controller 274 may, in some embodiments, control the RFID transceiver 270 by, for example, providing control signals that control when the RFID transceiver 270 transmits signals. The controller 274 may also, in some embodiments, control the switching circuit 272 by, for example, providing control signals that control the switching circuit 272 to enable a signal path between the RFID transceiver 270 and a particular one of the RFID antennas 240-263 at a time. By using the controller 274 to control the RFID transceiver 270 to sequentially activate all of the RFID antennas 240-263, the patch cord connectivity for the patch panel 200 may be determined (i.e., for each connector port 210-233, the unique identifier 295 of any intelligent patch cord 290 that is plugged into the connector port is determined). The controller 274 may be connected to a database or other storage system (not shown in FIG. 4) that may be used to store the patch cord connection information that is tracked using the RFID capabilities of the patch panel 200. The controller 274 may also be coupled to a user interface (not shown in FIG. 4) which may allow a system operator to make queries and receive information regarding the current (or historical) patch cord connections to the patch panel 200.

Appliqué circuit boards having RFID antennas, an RFID transceiver, and a controller, as described above, may be utilized for non-intelligent devices, such as LAN switches. These appliqué circuit boards contain the circuitry necessary to read RFID tags of tagged patched cords plugged into the switch. In some embodiments of the present invention, an appliqué circuit board is mounted to the front of each LAN switch port card in a patching field, and each appliqué circuit board is capable of reporting tag ID/switch port data to a local intelligent patching controller, thereby giving the controller in question the ability to determine patch cord connectivity between LAN switch ports and intelligent patch panel ports within a wiring closet by identifying switch ports and intelligent patch panel ports that have reported the same patch cord ID.

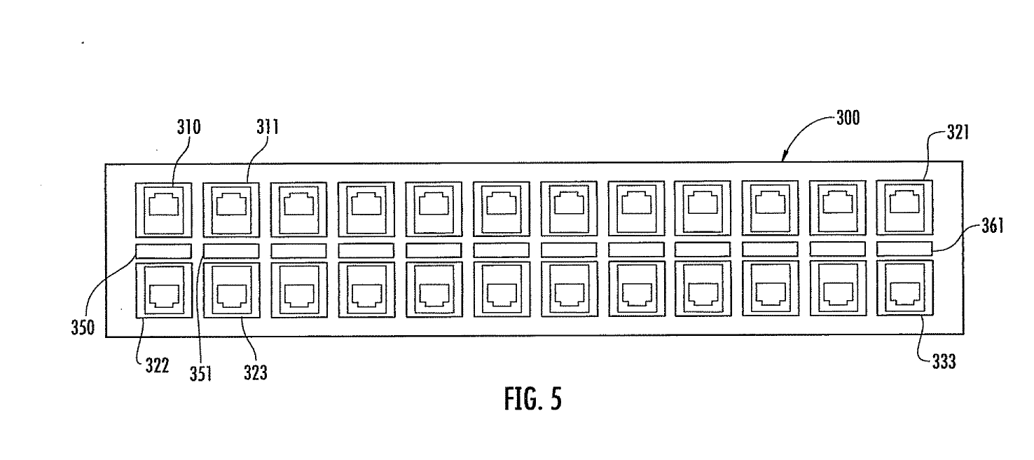

Non-intelligent devices may have a high density connector port configuration. For example, some LAN switch vendors place two rows of RJ-45 connector ports within a 1 U port card. At this connector port density, the space between individual RJ-45 connector ports is so small that it may be difficult to design an array of RFID antennas via an appliqué circuit board, for example, whereby each antenna reads only the RFID tag of patch cord plugs inserted into a single connector port. Instead the best that can be accomplished may be to place one RFID antenna between the top and bottom RJ-45 connector ports of each individual column of connector ports on the panel. FIG. 5 illustrates a LAN switch 300 having two rows of RJ-45 connector ports 310-321 and 322-333. A respective RFID antenna 350-361 is positioned between each respective pair of connector ports 310-321 and 322-333. For example, RFID antenna 350 is positioned between connector port pair 310 and 322, RFID antenna 351 is positioned between connector port pair 311 and 323, etc. Each RFID antenna 350-361 is configured to pick up data from RFID tags on patch cords inserted in either of the two RJ-45 connector ports positioned above and below the respective RFID antenna. For example, RFID antenna 350 is configured to pick up data from RFID tags on patch cords inserted in connector ports 310 and 322, RFID antenna 351 is configured to pick up data from RFID tags on patch cords inserted in connector ports 311 and 323, etc.

Embodiments of the present invention are not limited to switches (or other devices) with RFID antennas that are part of an appliqué circuit board that is mounted on the switch. According to other embodiments of the present invention, RFID antennas may be an integral part of the connector port design of a LAN switch (or other device).

When a device contains two rows of RJ-45 connector ports, as illustrated in FIG. 5, it may be a requirement that the upper row of connector ports be oriented such that the RJ-45 latch is facing upwards, and that the lower row of connectors be oriented such that the RJ-45 latch is facing downwards. This arrangement may be necessary because there may be insufficient space between the two rows of RJ-45 connector ports for a user's fingers to reach in and activate the RJ-45 latch on a patch cord if both the top and bottom connector ports within a given column are occupied at the same time. This connector port arrangement ensures that patch cord plugs inserted into the top and bottom rows of a high density LAN port card will differ with respect to their orientation to the earth's gravitational field by 180 degrees.

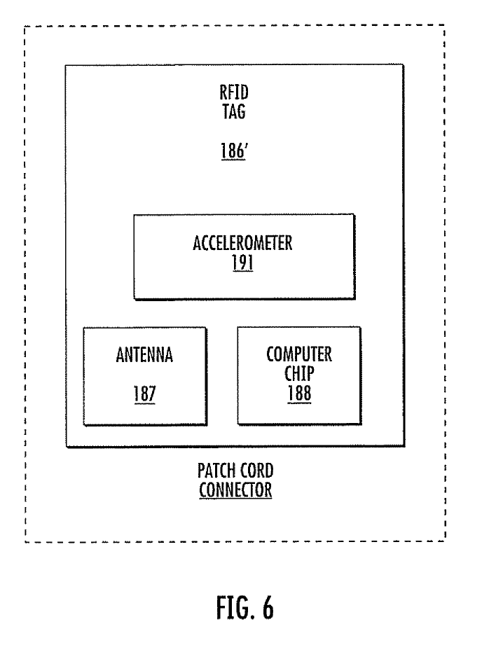

According to embodiments of the present invention, passive RFID tags for patch cords are provided with low-resolution, single axis accelerometers or other types of accelerometers. For example, as illustrated in FIG. 6, an RFID tag 186′ includes an accelerometer 191. The accelerometer 191 becomes active when the RFID tag 186′ is energized, and determines the tag's orientation with respect to the earth's gravitational field in real time. This orientation information is included with the data transmitted by the RFID tag 186′ back to the RFID transceiver (e.g., 180, FIG. 3).

In operation, at the time an RFID transceiver (e.g., 180, FIG. 3) reads the RFID tag 186′, the tag 186′ is fixed in place, and thus the accelerometer 191 need not compensate for forces associated with movement of the tag. Moreover, it is extremely rare that a patch cord plug will be in any orientation other than upward facing/downward facing (if the switch port card is mounted horizontally), or leftward facing/rightward facing (if the switch port card mounts vertically). Thus, the accelerometer 191 integrated into the RFID tag 186′ need only distinguish between four different orientations on a single axis, according to some embodiments of the present invention. For example, Table 1 below illustrates RFID tag orientation and exemplary corresponding accelerometer output data, according to some embodiments of the present invention.

TABLE 1

| Tag Orientation (0 | | |
|---|---|---|
| degrees = straight | Accelerometer | Interpretation of |
| up) | output data | accelerometer output |
| 316 to 45 degrees | 00 | Facing Up |
| 46 to 135 degrees | 01 | Facing Right |
| 136 to 225 degrees | 10 | Facing Down |
| 226 to 315 degrees | 11 | Facing Left |

Thus, as illustrated in Table 1, any orientation of a patch cord plug relative to horizontal or vertical can be determined using the accelerometer output data.

Referring back to FIG. 5, if RFID tags containing accelerometers, according to embodiments of the present invention, are attached to patch cords inserted within the connector ports 310-321 and 322-333 of switch 300, then when an intelligent patching controller activates one of the RFID antennas 350-361, the controller will be able to determine which of the two tag IDs it reads back is associated with the patch cord inserted in the upper RJ-45 connector port, and which is associated with the patch cord inserted in the lower RJ-45 connector port, by examining the tag orientation information reported back by the RFID tags. For example, the accelerometer associated with an RFID tag attached to a patch cord inserted within connector port 310 would output a signal that the RFID tag is facing down (i.e., 10 from Table 1). The accelerometer associated with an RFID tag attached to a patch cord inserted within connector port 322 would output a signal that the RFID tag is facing up (i.e., 00 from Table 1).

According to some embodiments of the present invention, an RFID tag's RFID transponder circuitry and a single-axis accelerometer may be combined on a single integrated circuit. Alternatively, an RFID tag's transponder circuitry and a single-axis accelerometer may be implemented as separate devices, where the RFID transponder integrated circuit includes sensor input contacts to which a stand-alone accelerometer (e.g., a MEMES accelerometer) would be connected.

According to some embodiments of the present invention, an RFID transceiver may follow an arbitration protocol, such that if several RFID tags are energized concurrently by the RFID transceiver, the transceiver has a method of identifying all of the tags that are currently energized, and can then enable each tag to transmit individually on a round-robin basis so that it can obtain data from each tag present without interference from the other tags. For example, with respect to FIG. 5, an RFID transceiver (e.g., 180, FIG. 3) will energize RFID tags 186′ attached to patch cords inserted within connector ports 310 and 322 when RFID antenna 350 receives a signal from the RFID transceiver. In order to obtain data from the two RFID tags without interference from each other, the RFID transceiver follows an arbitration protocol. Arbitration protocols are understood by those skilled in the art and need not be described further herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An RFID tag, comprising an accelerometer that is configured to determine an orientation of the RFID tag and to generate an orientation signal associated with the RFID tag orientation when the RFID tag is energized.

2. The RFID tag of claim 1, wherein the accelerometer is a single axis accelerometer.

3. The RFID tag of claim 1, wherein the accelerometer is configured to determine the orientation of the RFID tag relative to the gravitational field of the earth.

4. A patch cord for a communications patching system, comprising:
a cable;
a connector secured to an end of the cable; and
an RFID tag secured to the connector, wherein the RFID tag comprises an accelerometer that is configured to determine an orientation of the RFID tag.

5. The patch cord of claim 4, wherein the accelerometer is a single axis accelerometer that is configured to generate an orientation signal associated with the RFID tag orientation when the RFID tag is energized.

6. The patch cord of claim 4, wherein the accelerometer is configured to determine the orientation of the RFID tag relative to the gravitational field of the earth.

7. The patch cord of claim 4, wherein the patch cord is an electrical patch cord.

8. The patch cord of claim 4, wherein the patch cord is an optical patch cord.

9. A patch cord configured to selectively interconnect pairs of connector ports in a communications patching system, comprising:
a communications cable comprising opposite ends;
a respective connector secured to each cable end, wherein each connector is configured to be removably secured within a connector port; and
an RFID tag associated with each connector, wherein each RFID tag is configured to transmit information stored therewithin when the RFID tag is energized, and wherein each RFID tag comprises an accelerometer that is configured to determine an orientation of the respective RFID tag and to generate an orientation signal associated with the RFID tag orientation.

10. The patch cord of claim 9, wherein the RFID tags have the same unique identifier stored therewithin, and wherein the orientation signal is generated when the RFID tag is energized.

11. A communications patching system, comprising:
a communications device comprising first and second connector ports;
an RFID antenna positioned adjacent to the first and second connector ports;
an RFID transceiver that is coupled to the RFID antenna; and
at least one patch cord that comprises an end and a connector secured to the end, wherein the connector is configured to be removably secured within the first and second connector ports, wherein the connector comprises an RFID tag, and wherein the RFID tag comprises an accelerometer that is configured to determine an orientation of the RFID tag and to generate an orientation signal associated with the RFID tag orientation when the RFID tag is energized by the RFID transceiver via the RFID antenna.

12. The communications patching system of claim 11, wherein the RFID tag has an identifier stored therewithin, and wherein the RFID tag transmits the identifier when the RFID tag is energized by the RFID transceiver.

13. The communications patching system of claim 11, comprising a plurality of patch cords, wherein each patch cord comprises opposite ends and a respective connector secured to each end, wherein each connector comprises an RFID tag, and wherein the RFID tags for a respective patch cord have the same unique identifier stored therewithin.

14. The communications patching system of claim 11, wherein the RFID transceiver follows an arbitration protocol to sequentially obtain data from RFID tags secured to connectors within the first and second connector ports, and wherein the RFID tags support the arbitration protocol.

15. The communications patching system of claim 14, further comprising a database that monitors and logs patch cord interconnections with the connector ports, and wherein the RFID transceiver is in communication with the database.

16. A method of determining patch cord connectivity information in a patching system, wherein the patching system includes a pair of connector ports, an RFID antenna adjacent the pair of connector ports, and a respective pair of patch cords inserted within the connector ports, wherein each patch cord includes an RFID tag having an accelerometer that is configured to determine an orientation of the RFID tag and to generate an orientation signal associated with the RFID tag orientation when the RFID tag is energized, the method comprising:
energizing the patch cord RFID tags to cause each accelerometer to determine an orientation of its RFID tag and to emit an orientation signal;
receiving the orientation signal of each RFID tag; and
identifying which patch cord is inserted within which connector port using the received orientation signals.

17. The method of claim 16, wherein each accelerometer is a single axis accelerometer.

18. The method of claim 16, wherein each accelerometer is configured to determine the orientation of a respective RFID tag relative to the gravitational field of the earth.

19. The method of claim 16, wherein the orientation signal of each RFID tag is received according to an arbitration protocol.
